(19) United States
(12) Patent Application Publication
(10) Pub. No.: US 2022/0094886 A1
(43) Pub. Date: Mar. 24, 2022

(54) CAMERA DEVICE, AND ELECTRONIC APPARATUS INCLUDING THE SAME

(71) Applicant: LG ELECTRONICS INC., Seoul (KR)

(72) Inventors: Jiwon LEE, Seoul (KR); Dongkyu LEE, Seoul (KR); Aram KIM, Seoul (KR); Heungsoon YOON, Seoul (KR); Jaehyun AN, Seoul (KR); Jinkyoo LEE, Seoul (KR)

(73) Assignee: LG ELECTRONICS INC., Seoul (KR)

(21) Appl. No.: 17/424,400

(22) PCT Filed: Jan. 21, 2020
(86) PCT No.: PCT/KR2020/001046

§ 371 Date: Jul. 20, 2021

(30) Foreign Application Priority Data
Jan. 21, 2019 (KR) 10-2019-0007250

(51) Int. Cl. H04N 9/04

(52) U.S. Cl. CPC H04N 9/04553; H04N 9/04515; H04N 9/04559

(57) ABSTRACT

The present disclosure relates to a camera device, and an electronic apparatus including the same. The camera device and an electronic apparatus including the same according to an embodiment of the present disclosure includes a lens device, an image sensor configured to convert light passing through the lens device into an electrical signal to generate an RGBN pattern image, and a processor configured to output a multi-spectrum-based IR image and an RGB-based color image based on the RGBN pattern image from the image sensor. Accordingly, it is possible to obtain the color image and the IR image robust to illuminance.

### BACKGROUND OF THE DISCLOSURE

### 1. Field of the Disclosure

The present disclosure relates to a camera device, and an electronic apparatus including the same, and more particularly, to a camera device capable of obtaining a color image and an IR image robust to low illuminance, and an electronic apparatus including the same.

### 2. Description of the Related Art

A camera device is an image capturing device. Recently, cameras are employed in various electronic devices.

Meanwhile, a camera device is used to acquire a color image. Recently, for distance detection or the like, the camera device is also used to acquire an IR image.

Conventionally, a color camera and an IR camera are used to acquire a color image and an IR image, respectively.

In this case, in order to acquire the color image from the color camera and the IR image from an IR camera, each image sensor is required, and a processor for signal processing of the color image and the IR image is required, respectively.

However, in this case, since the IR image is generated based on the IR image sensor, there is a disadvantage in that an IR image that is not robust is obtained in a low illuminance environment.

### SUMMARY

The present disclosure provides a camera device capable of acquiring a color image and an IR image robust to illuminance, and an electronic apparatus including the same.

The present disclosure also provides a camera device capable of acquiring a color image and an IR image robust to illuminance by using one image sensor, and an electronic apparatus including the same.

The present disclosure also provides a camera device capable of acquiring a color image and an IR image robust to noise and artifacts, and an electronic apparatus including the same.

In an aspect, there are provided a camera device and an electronic apparatus including the same. The camera device includes a lens device, an image sensor configured to convert light passing through the lens device into an electrical signal to generate an RGBN pattern image, and a processor configured to output a multi-spectrum-based IR image and an RGB-based color image based on the RGBN pattern image from the image sensor.

Meanwhile, the image sensor may include an RGBN filter configured to filter the light passing through the lens device into an RGBN pattern, and a sensor array configured to convert the light from the RGBN filter into an electrical signal.

Meanwhile, the RGBN filter may filter infrared light and visible light into an RGBN pattern.

The processor may include an IR image generator configured to generate the multi-spectrum-based IR image based on the RGBN pattern image from the image sensor, and a color image generator configured to generate the RGB-based color image based on the RGBN pattern image from the image sensor.

The processor may further include a first color estimator configured to estimate a first color based on the RGBN pattern image from the image sensor, and the color image generator may convert an N pattern in the RGBN pattern image into a first color pattern and output the RGB-based color image.

The processor may output a multi-spectrum-based IR image having a resolution smaller than a resolution of the RGBN pattern image.

The processor may output a multi-spectrum-based IR image having the same resolution as the RGBN pattern image.

The camera device may further include an IR output device configured to output infrared light, and the processor may estimate brightness based on the RGBN pattern image, and output a control signal for controlling an operation of the IR output device based on the estimated brightness.

The processor may estimate the brightness based on the RGBN pattern image, and when the estimated brightness level is equal to or less than a reference level, control the IR output device to output the infrared light.

The camera device may further include an illuminance sensor, and when the illuminance level sensed by the illuminance sensor is equal to or less than a second reference level, the processor may control the IR output device to output the infrared light.

Levels for each wavelength of the multi-spectrum may be larger than that of an IR spectrum.

The camera device may further include an IR output device configured to output infrared light, and the processor may output the multi-spectrum-based IR image and the RGB-based color image during the operation of the IR output device.

The camera device may further include an IR output device configured to output infrared light, and when an operation of the IR output device stops, the processor may output only the RGB-based color image without outputting the multi-spectrum-based IR image.

### Effects of the Disclosure

According to an embodiment of the present disclosure, there are provided a camera device and an electronic apparatus including the same. The camera device includes a lens device, an image sensor configured to convert light passing through the lens device into an electrical signal to generate an RGBN pattern image, and a processor configured to output a multi-spectrum-based IR image and an RGB-based color image based on the RGBN pattern image from the image sensor. As a result, it is possible to acquire a color image and an IR image robust to illuminance.

In particular, it is possible to acquire the color image and the IR image robust to illuminance by using one image sensor. In addition, it is possible to acquire the color image and the IR image robust to noise and artifacts.

Meanwhile, the image sensor may include an RGBN filter configured to filter the light passing through the lens device into an RGBN pattern, and a sensor array configured to convert the light from the RGBN filter into an electrical signal. Accordingly, it is possible to obtain the color image and the IR image robust to illuminance.

Meanwhile, the RGBN filter may filter infrared light and visible light into an RGBN pattern. Accordingly, it is possible to obtain the color image and the IR image robust to illuminance.

Meanwhile, the processor may include an IR image generator configured to generate the multi-spectrum-based IR image based on the RGBN pattern image from the image sensor, and a color image generator configured to generate the RGB-based color image based on the RGBN pattern image from the image sensor. Accordingly, it is possible to obtain the color image and the IR image robust to illuminance.

Meanwhile, the processor may further include a first color estimator configured to estimate a first color based on the RGBN pattern image from the image sensor, and the color image generator may convert an N pattern in the RGBN pattern image into a first color pattern and output the RGB-based color image. Accordingly, it is possible to obtain the color image and the IR image robust to illuminance.

Meanwhile, the processor may output a multi-spectrum-based IR image having a resolution smaller than a resolution of the RGBN pattern image. Accordingly, it is possible to obtain the color image and the IR image robust to illuminance.

Meanwhile, the processor may output a multi-spectrum-based IR image having the same resolution as the RGBN pattern image. Accordingly, it is possible to obtain the color image and the IR image robust to illuminance.

Meanwhile, the camera device may further include an IR output device configured to output infrared light, and the processor may estimate brightness based on the RGBN pattern image, and output a control signal for controlling an operation of the IR output device based on the estimated brightness. Accordingly, it is possible to obtain the color image and the IR image robust to illuminance.

Meanwhile, the processor may estimate the brightness based on the RGBN pattern image, and when the estimated brightness level is equal to or less than a reference level, control the IR output device to output the infrared light. Accordingly, it is possible to obtain the color image and the IR image robust to illuminance.

Meanwhile, the camera device may further include an illuminance sensor, and when the illuminance level sensed by the illuminance sensor is equal to or less than a second reference level, the processor may control the IR output device to output the infrared light. Accordingly, it is possible to obtain the color image and the IR image robust to illuminance.

Meanwhile, it is preferable that levels for each wavelength of the multi-spectrum are larger than that of an IR spectrum. Accordingly, it is possible to obtain the color image and the IR image robust to illuminance.

Meanwhile, the camera device may further include an IR output device configured to output infrared light, and the processor may output the multi-spectrum-based IR image and the RGB-based color image during the operation of the IR output device. Accordingly, it is possible to obtain the color image and the IR image robust to illuminance.

Meanwhile, the camera device may further include an IR output device configured to output infrared light, and when an operation of the IR output device is stopped, the processor may output only the RGB-based color image without outputting the multi-spectrum-based IR image. Accordingly, it is possible to obtain the color image and the IR image robust to illuminance.

### BRIEF DESCRIPTION OF THE DRAWINGS

FIG. 1A is a diagram illustrating an example of an appearance of a camera device according to the present disclosure;

FIG. 1B is a diagram illustrating another example of the appearance of the camera device according to the present disclosure;

FIG. 2 is a diagram explaining various examples of an electronic device;

FIG. 3A is a diagram referenced in a description of an operation of the camera device of FIG. 1B;

FIG. 3B is an internal cross-sectional view of a color camera and an IR camera of FIG. 1B;

FIG. 3C is an internal block diagram of the camera device of FIG. 1B;

FIGS. 4A to 4C are diagrams referenced in the description of the operation of the camera device of FIG. 3A;

FIG. 5A is a diagram referenced in a description of an operation of a camera device according to an embodiment of the present disclosure;

FIG. 5B is an internal cross-sectional view of the camera device of FIG. 5A;

FIG. 5C is an internal block diagram of the camera device of FIG. 5A;

FIGS. 6A to 7B are diagrams referenced in the description of the operation of the camera device of FIG. 3A;

FIG. 8 is a flowchart illustrating a method of operating a camera device according to an embodiment of the present disclosure; and

FIGS. 9 to 18C are diagrams referenced in the description of the operation method of FIG. 8.

### DETAILED DESCRIPTION OF THE PREFERRED EMBODIMENTS

Hereinafter, the present disclosure will be described in detail with reference to the accompanying drawings.

With respect to constituent elements used in the following description, suffixes “module” and “unit” are given only in consideration of ease in the preparation of the specification, and do not carry any important meaning or role. Therefore, the suffixes “module” and “unit” may be used interchangeably.

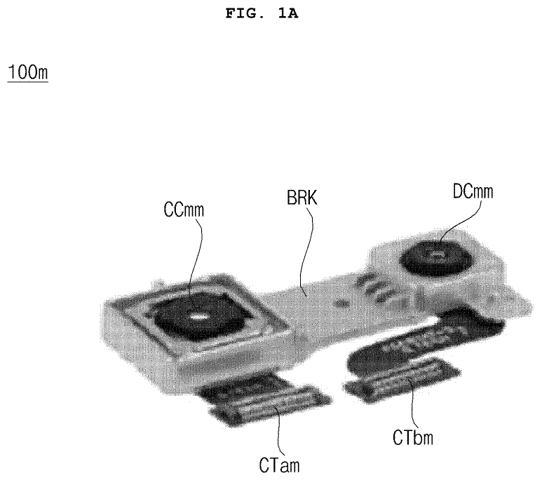

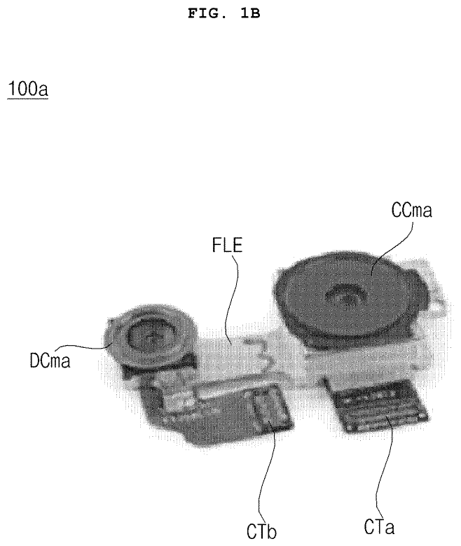

FIG. 1A is a diagram illustrating an example of an appearance of a camera device according to the present disclosure.

Referring to FIG. 1A, a camera device 100m may include a color camera CCmm, an IR camera DCmm, a bracket BRK fixing the color camera CCmm and the IR camera DCmm, an interface CTam of the color camera CCmm, and an interface CTbm of the IR camera DCmm.

Due to the bracket BRK for fixing the color camera CCmm and the IR camera DCmm in the camera device 100m according to FIG. 1A, there may be limitations in designing a space of the camera device 100m or an electronic device in which the camera device 100m is mounted.

FIG. 1B is a diagram illustrating another example of the appearance of the camera device according to the present disclosure.

Referring to FIG. 1B, a camera device 100a may include a color camera CCma, an IR camera DCma, a connection member FLE connecting the color camera CCma and the IR camera DCma, an interface CTa of the color camera CCma, and an interface CTb of the IR camera DCma.

Meanwhile, the connection member FLE connecting the color camera CCma and the IR camera DCma may be flexible. That is, unlike FIG. 1A, the bracket BRK may not be provided. Accordingly, since there is no bracket, the degree of freedom in spatial design of the camera device 100a or the electronic apparatus in which the camera device 100a is mounted may be improved.

On the other hand, the camera device 100m of FIG. 1A or the camera device 100a of FIG. 1B is divided into a color camera and an IR camera, respectively, and the color camera and the IR camera will use a separate image sensor to acquire a color image and an IR image, respectively.

In this case, since the color image and the IR image are output by a separate image sensor, a noisy color image and IR image are acquired in an illuminance environment.

Accordingly, in the present disclosure, a camera device 100 capable of obtaining a color image and an IR image robust to illuminance is proposed.

In particular, in the present disclosure, the camera device 100 capable of obtaining the color image and the IR image robust to illuminance by using one image sensor is proposed.

In addition, the present disclosure proposes a camera device 100 capable of acquiring a color image and an IR image robust to noise and artifacts.

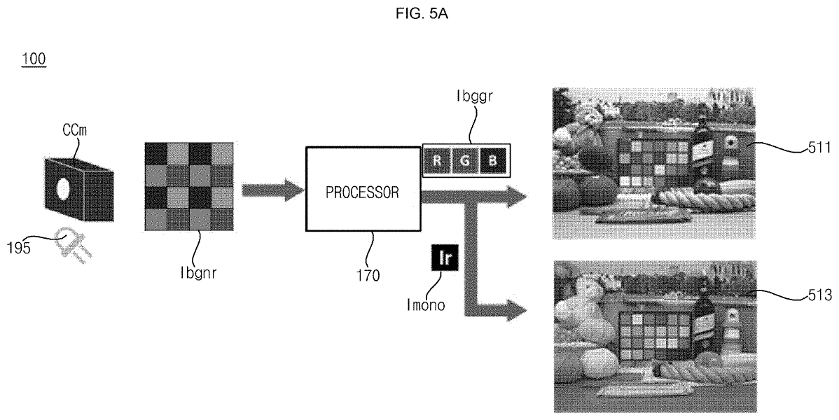

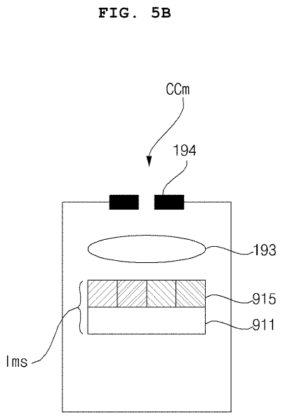

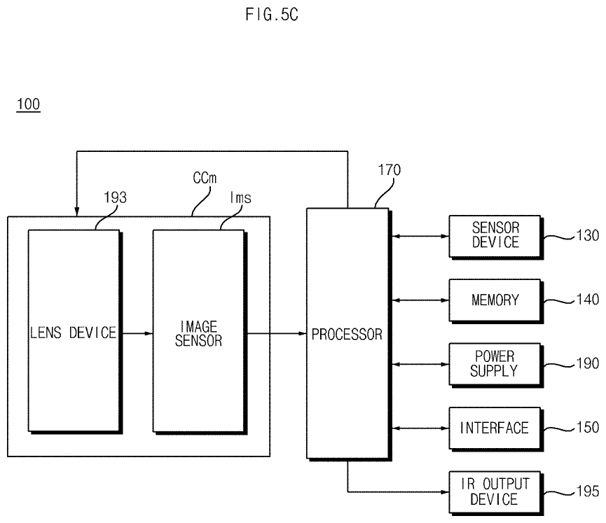

A description of the camera device 100 according to the embodiment of the present disclosure will be described below with reference to FIG. 5A.

Meanwhile, the camera device 100 according to the embodiment of the present disclosure may be provided in various electronic apparatuses.

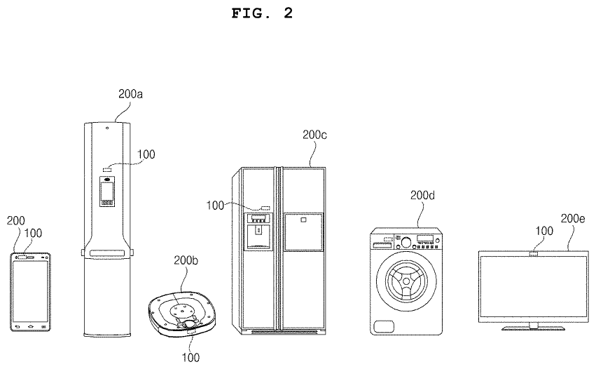

FIG. 2 is a diagram explaining various examples of an electronic device.

Referring to FIG. 2, the camera device 100 according to the embodiment of the present disclosure may be adopted in various electronic apparatuses such as a mobile terminal 200, an air conditioner 200a, a robot cleaner 200b, a refrigerator 200c, a washing machine 200d, a TV 200e, a vehicle, and a drone.

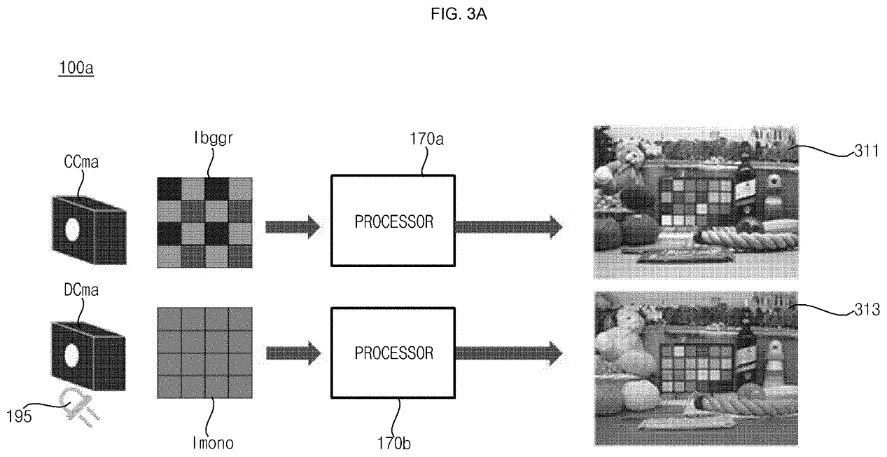

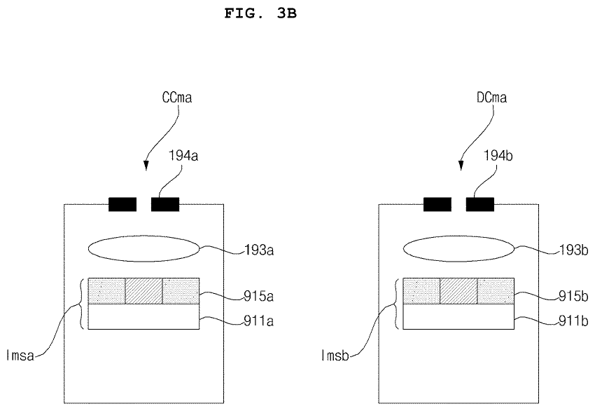

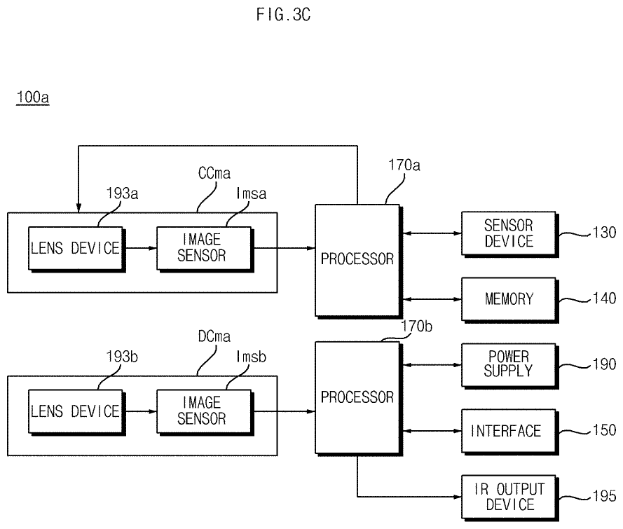

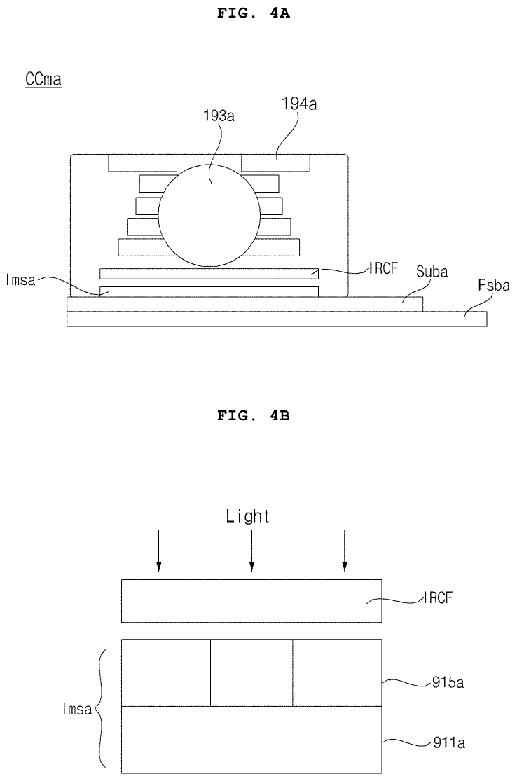

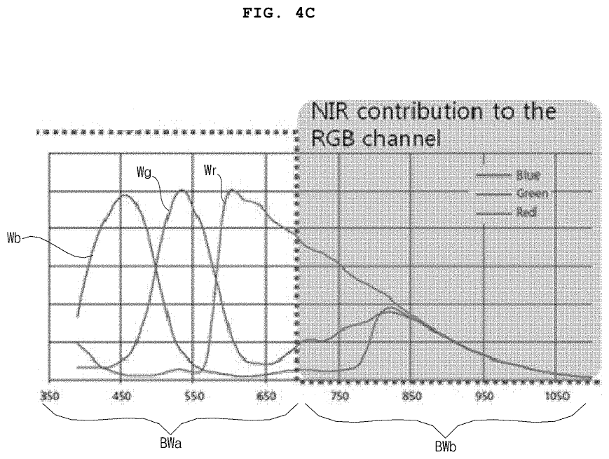

FIG. 3A is a diagram referenced in a description of an operation of the camera device of FIG. 1B.

Referring to the drawing, a camera device 100a may include the color camera CCma, the IR camera Dcma, and processors 170a and 170b.

The color camera CCma may output a color pattern image Ibggr based on the color pattern, and the IR camera Dcma may output an IR image Imono based on an IR pattern or a mono pattern.

The processor 170a may perform signal processing on the color pattern image Ibggr based on the color pattern and output the color image 311.

The processor 170b may output an IR image 313 by performing signal processing on an IR image Imono based on the IR pattern or the mono pattern.

FIG. 3B is an internal cross-sectional view of a color camera and an IR camera of FIG. 1B.

Referring to the drawing, the color camera CCma may include an aperture 194a, a lens device 193a, and an image sensor Imsa.

For sensing RGB colors, the image sensor Imsa may include a RGb filter 915a, and a sensor array 911a for converting an optical signal into an electrical signal.

Accordingly, the image sensor Imsa may sense and output a color image.

The IR camera DCma may include an aperture 194b, a lens device 193b, and an image sensor Imsb.

For sensing an IR image, the image sensor Imsb may include an IR filter 915b, and a sensor array 911a for converting an optical signal into an electrical signal.

Accordingly, the image sensor Imsb may sense and output an IR image.

FIG. 3C is an internal block diagram of the camera device including the color camera and IR camera of FIG. 1B.

Referring to the drawing, the camera device 100a may include the color camera CCma, the IR camera Dcma, the processors 170a and 170b, the sensor device 130, the memory 140, the power supply 190, and the interface 150.

The color camera CCma may include the lens device 193a and the image sensor Imsa to output a color image.

The lens device 193a in the color camera CCma receives incident light and may include a plurality of lenses.

Meanwhile, an exposure time of the image sensor Imsa may be adjusted based on an electronic signal.

The IR camera DCma may include the lens device 193b and the image sensor Imsb for outputting an IR image.

The lens device 193b in the IR camera DCm receives the incident light and may include a plurality of lenses.

The processor 170a may perform signal processing on a color pattern image based on the color pattern IBggr to output a color image 311.

The processor 170b may output the IR image 313 by performing signal processing on the IR image based on the IR pattern or the mono pattern.

The sensor device 130 may sense movement information, location information, or the like of the camera device 100a.

The memory 140 may store data for the operation of the camera device 100a, or the like.

The interface 150 may be used for data transmission with other devices in the camera device 100a.

The power supply 190 may supply power for the operation of the camera device 100a.

FIGS. 4A to 4C are diagrams referenced in the description of the operation of the camera device of FIG. 3A.

First, referring to FIG. 4A, the color camera CCma of the camera device 100a includes an aperture 194a, a lens device 193a, an infrared cut-off filter IRCF, an image sensor Imsa, a substrate Suba, and a flexible substrate Fsba.

The light incident on the aperture 194a passes through the lens device 193a and the infrared cut filter IRCF, and is converted into an electrical signal by the image sensor Imsa, and the converted electrical signal may be transmitted to the processor 170a or the like through the substrate Suba and the flexible substrate Fsba.

Meanwhile, referring to FIG. 4B, the image sensor Imsa may include an RGB filter 915a for sensing RGB colors and a sensor array 911a for converting an optical signal into an electrical signal.

FIG. 4C illustrates that an input optical signal is cut-off by an infrared cut filter (IRCF).

Referring to the drawing, blue light Wb, green light Wg, and red light Wr corresponding to the first band BWa are not cut-off by the infrared cut-off filter IRCF, but are incident on the image sensor Imsa, respectively.

Meanwhile, infrared light corresponding to a second band BWb is cut-off by the infrared cut-off filter IRCF and is not incident on the image sensor Imsa.

Accordingly, the processor 170a outputs a color image based on visible light from which infrared light is excluded.

Meanwhile, similarly to this, the processor 170b outputs an IR image based on infrared light.

As illustrated in FIGS. 3A to 4C, when the color camera CCma and the IR camera Dcma are separated in the camera device 100a and each process signals to output the color image and the IR image, a light loss occurs due to the infrared cut-off filter (IRCF) or the like, so a noisy color image and an IR image are acquired in a dark illuminance environment.

Accordingly, in the present disclosure, a camera device 100 capable of obtaining a color image and an IR image robust to illuminance is proposed.

In particular, in the present disclosure, the camera device 100 capable of obtaining the color image and the IR image robust to illuminance by using one image sensor is proposed.

In addition, the present disclosure proposes a camera device 100 capable of acquiring a color image and an IR image robust to noise and artifacts.

FIG. 5A is a diagram referenced in a description of an operation of a camera device according to an embodiment of the present disclosure.

Referring to the drawing, the camera device 100a may include a color IR camera CCm and a processor 170.

The color IR camera CCm may output an RGBN pattern image Ibgnr based on the color IR pattern IBggr.

The processor 170 may perform the signal processing based on the RGBN pattern image Ibgnr to output an RGB-based color image 511 and an IR-based IR image 513.

In particular, the processor 170 may output a multi-spectrum-based IR image and an RGB-based color image based on the RGBN pattern image Ibgnr.

Accordingly, it is possible to obtain the color image and the IR image robust to illuminance. Also, the overall dynamic range of the color image and the IR image is increased.

In particular, the color image and the IR image robust to illuminance may be acquired by using one image sensor Ims in the color IR camera CCm. In addition, it is possible to acquire the color image and the IR image robust to noise and artifacts.

FIG. 5B is an internal cross-sectional view of the camera device of FIG. 5A.

Referring to FIG. 5, a color IR camera CCm may include an aperture 194, a lens device 193, and an image sensor Ims.

The aperture 194 may open and close light incident on the lens device 193.

The lens device 193 may include a plurality of lenses that are adjusted for variable focus.

The image sensor Ims may include an RGBN filter 915 and a sensor array 911 that converts an optical signal into an electrical signal to sense the RGB colors and the IR image.

Accordingly, the image sensor Ims may sense and output the RGBN pattern image.

Meanwhile, the RGBN pattern image may be referred to as an RGBN bayer pattern image.

FIG. 5C is an internal block diagram of the camera device of FIG. 5A.

Referring to FIG. 5C, the camera device 100 may include a color IR camera CCm, a processor 170, a sensor device 130, a memory 140, an interface 150, a power supply 190, an IR output device 195.

The color IR camera CCm may include a lens device 193 and an image sensor Ims for outputting a color image.

The lens device 193 in the color IR camera CCm may receive the incident light and include a plurality of lenses that are adjusted for variable focus.

Meanwhile, the processor 170 may output a control signal for moving a position of at least one of the plurality of lenses to the lens device 193 for focus adjustment.

The image sensor Ims includes an RGBN filter 915 configured to filter infrared light and visible light into an RGBN pattern, and a sensor array 911 configured to convert an optical signal into an electrical signal in order to sense the RGB colors and the IR image.

Accordingly, the image sensor Ims may sense and output the RGBN pattern image Ibgnr.

The processor 170 may receive the RGBN pattern image Ibgnr from the image sensor Ims, and generate and output the multi-spectrum-based IR image and the RGB-based color image based on the RGBN pattern image Ibgnr.

Accordingly, it is possible to acquire the color image Ibggr and the IR image Imono robust to illuminance. In addition, it is possible to acquire the color image Ibggr and the IR image Imono robust to noise and artifacts.

Meanwhile, the processor 170 may output the multi-spectrum-based IR image Imono having a resolution smaller than a resolution of the RGBN pattern image Ibgnr. Accordingly, it is possible to acquire the color image Ibggr and the IR image Imono robust to illuminance.

Meanwhile, the processor 170 may output the multi-spectrum-based IR image Imono having the same resolution as the RGBN pattern image Ibgnr. Accordingly, it is possible to acquire the color image Ibggr and the IR image Imono robust to illuminance.

Meanwhile, the processor 170 may estimate the brightness based on the RGBN pattern image Ibgnr, and output the control signal for controlling the operation of the IR output device 195 based on the estimated brightness. Accordingly, it is possible to acquire the color image Ibggr and the IR image Imono robust to illuminance.

Meanwhile, the processor 170 may estimate the brightness based on the RGBN pattern image Ibgnr, and when the estimated brightness level is equal to or less than the reference level, control the IR output device 195 to output the infrared light. Accordingly, it is possible to acquire the color image Ibggr and the IR image Imono robust to illuminance.

Meanwhile, when the illuminance level sensed by the illuminance sensor (not illustrated) in the sensor device 130 is equal to or less than the second reference level, the processor 170 may control the IR output device 195 to output the infrared light. Accordingly, it is possible to acquire the color image Ibggr and the IR image Imono robust to illuminance.

Meanwhile, the processor 170 may output the multi-spectrum-based IR image Imono and the RGB-based color image Ibggr during the operation of the IR output device 195. Accordingly, it is possible to acquire the color image Ibggr and the IR image Imono robust to illuminance.

Meanwhile, when the operation of the IR output device 195 is stopped, the processor 170 may output only the RGB-based color image Ibggr without outputting the multi-spectrum-based IR image Imono. Accordingly, it is possible to acquire the color image Ibggr and the IR image Imono robust to illuminance.

Meanwhile, the processor 170 may compare the brightness component of the color image with the brightness component of the IR image, calculate error information, and compensate for at least one of the color image and the IR image based on the calculated error information, thereby outputting the compensated color image or the compensated IR image.

The sensor device 130 may sense movement information, position information, or the like of the camera device 100. To this end, the sensor device 130 may include a GPS receiver, an inertial sensor (gyro sensor, acceleration sensor, etc.), and the like.

Meanwhile, the sensor device 130 may include an illuminance sensor configured to sense illuminance around the camera device 100.

The memory 140 may store data for the operation of the camera device 100 or the RGBN pattern image from the color IR camera CCm.

Alternatively, the memory 140 may store the color image or the IR image generated and output by the processor 170.

The interface 150 may be used for data transmission with other devices of the camera device 100.

The power supply 190 may supply power for operation of the camera device 100.

For example, the power supply 190 may convert DC power or AC power input to the outside, and convert the converted DC power to the processor 170, the color IR camera CCm, the sensor device 130, and the memory 140, the interface 150, the IR output device 195, and the like.

The IR output device 195 may output the infrared light to the periphery of the camera device 100.

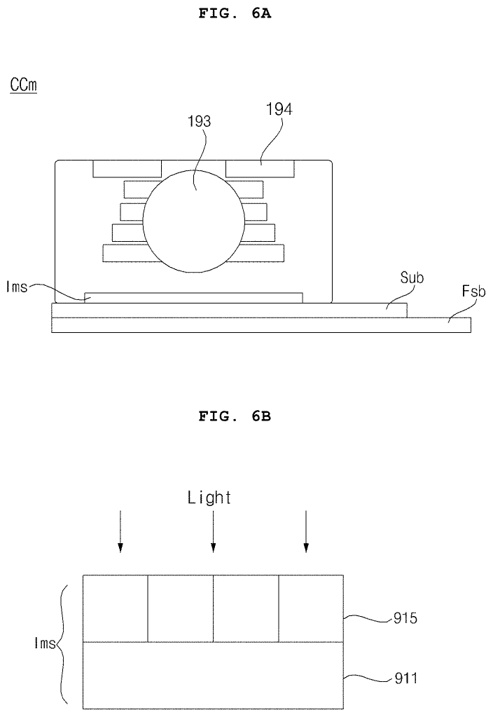

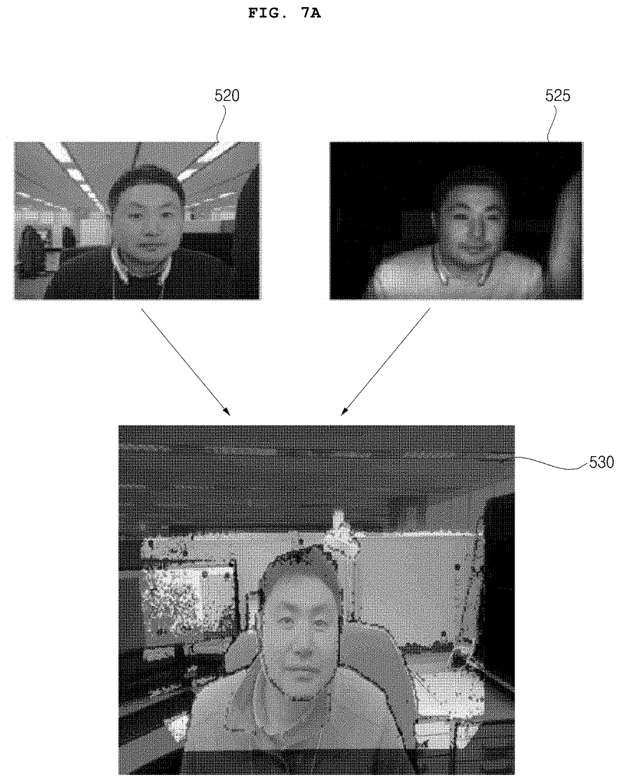

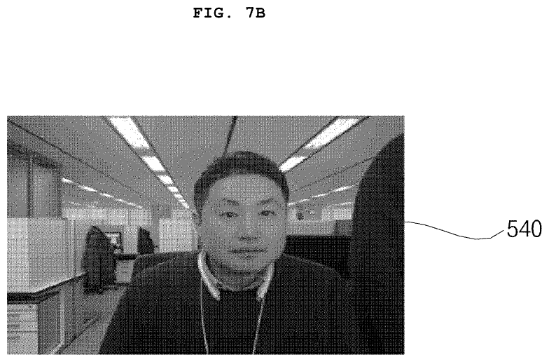

FIGS. 6A to 7B are diagrams referenced in the description of the operation of the camera device of FIG. 3A.

First, referring to FIG. 6A, the color IR camera CCm of the camera device 100 may include the aperture 194, the lens device 193, the image sensor Ims, a substrate Sub, and a flexible substrate Fsb.

The light incident on the aperture 194a passes through the lens device 193a and the infrared cut-off filter IRCF, and is converted into an electrical signal by the image sensor Imsa, and the converted electrical signal may be transmitted to the processor 170a or the like through the substrate Suba and the flexible substrate Fsba.

Meanwhile, comparing the camera device 100 of FIG. 6A and the camera device 100 of FIG. 4A, there is a difference in that the infrared cut-off filter (IRCF) is not provided.

Since the camera device 100 of FIG. 6A does not cut-off a second band BWb of FIG. 4C, a wide range of colors can be expressed at the time of generating the color image, and the multi-spectrum-based IR image can be generated at the time of generating the IR image.

Meanwhile, referring to FIG. 6B, the image sensor Ims may include the RGBN filter 915 configured to filter the light passing through the lens device 193 into the RGBN pattern, and the sensor array 911 configured to convert light from the RGBN filter 915 into an electrical signal.

Meanwhile, the RGBN filter 915 may be a 2*2 pattern filter, a 1*4 pattern, or a 4*1 pattern.

FIG. 7A illustrates a color image 520 and an IR image 525 processed by the processor 170.

Meanwhile, the processor 170 may perform matching using the color image 520 and the IR image 525.

For example, the processor 170 may match the IR image 525 to the color image 520. Then, the processor 170 may calculate the error information based on the difference.

For example, the processor 170 may calculate 3D error information by analyzing each feature point based on the IR image 525 in the color image 520.

Specifically, the processor 170 may analyze each feature point based on the IR image 525 in the color image 520, and calculate three-dimensional error information such as relative rotation information, relative translation information, relative shift information, or the like between the color image 520 and the IR image 525.

In addition, the processor 170 may output the compensated color image or the compensated IR image based on the calculated 3D error information.

FIG. 7B illustrates a compensated color image 540. Unlike FIG. 7B, it is also possible to output the compensated IR image. Accordingly, it is possible to acquire a vivid color image and IR image. In particular, it is possible to acquire the color image and the IR image robust to illuminance.

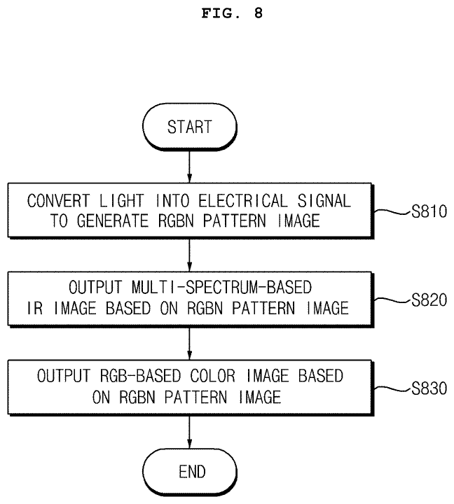

FIG. 8 is a flowchart illustrating a method of operating a camera device according to an embodiment of the present disclosure.

Referring to FIG. 8, the image sensor Ims in the camera device 100 may convert light into an electrical signal to generate the RGBN pattern image Ibgnr (S815).

The processor 170 in the camera device 100 may generate and output the multi-spectrum-based IR image Imono based on the RGBN pattern image Ibgnr from the image sensor Ims (S820).

On the other hand, the image sensor Ims may include an RGBN filter 915 configured to filter the light passing through the lens device 193 into the RGBN pattern, and the sensor array 911 configured to convert the light from the RGBN filter 915 into the electrical signal.

Meanwhile, the RGBN filter 915 may filter the infrared light and the visible light into the RGBN pattern.

Meanwhile, the processor 170 in the camera device 100 may generate and output the RGB-based color image Ibggr based on the RGBN pattern image Ibgnr from the image sensor Ims (S830).

Accordingly, it is possible to acquire the color image Ibggr and the IR image Imono robust to illuminance. In addition, it is possible to acquire the color image Ibggr and the IR image Imono robust to noise and artifacts.

Meanwhile, the processor 170 may output the multi-spectrum-based IR image Imono having a resolution smaller than a resolution of the RGBN pattern image Ibgnr.

Alternatively, the processor 170 may output the multi-spectrum-based IR image Imono having the same resolution as the RGBN pattern image Ibgnr. Accordingly, it is possible to acquire the color image Ibggr and the IR image Imono robust to illuminance.

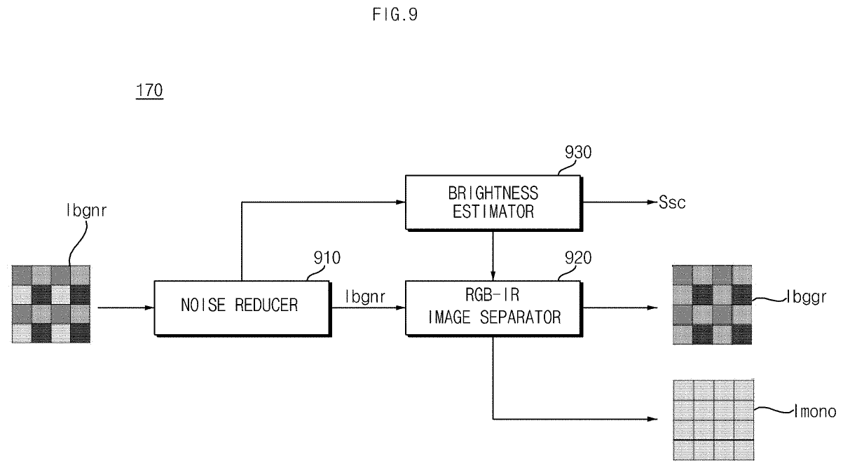

FIGS. 9 to 18C are diagrams referenced in the description of the operation method of FIG. 8.

First, FIG. 9 illustrates an example of an internal block diagram of the processor 170.

Referring to FIG. 9, the processor 170 may include a noise reducer 910, an image separator 920, and a brightness estimator 930.

The processor 170 may receive the RGBN pattern image Ibgnr from the image sensor Ims.

Accordingly, the noise reducer 910 in the processor 170 may receive the RGBN pattern image Ibgnr.

The noise reducer 910 may perform noise reduction in the received RGBN pattern image Ibgnr.

For example, the noise reducer 910 may correct a bad pixel in the received RGBN pattern image Ibgnr or perform the noise reduction.

The image separator 920 may receive the RGBN pattern image Ibgnr from the noise reducer 910 and separate the RGB pattern image and the IR image from the RGBN pattern image Ibgnr.

In particular, the image separator 920 may separate the RGB pattern image and the IR image from the RGBN pattern image Ibgnr, and generate and output an RGB-based color image and an IR-based IR image.

Meanwhile, the image separator 920 may perform Demosaicing to output the RGB-based color image and the IR-based IR image.

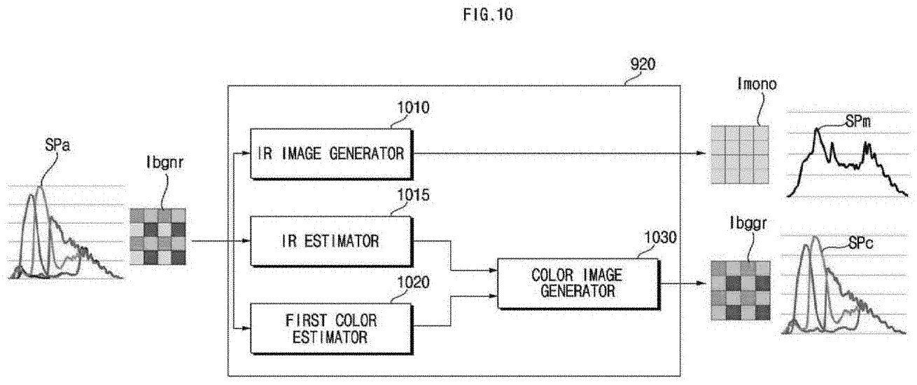

Meanwhile, a detailed operation of the image separator 920 will be described later with reference to FIG. 10 and the like.

Meanwhile, the brightness estimator 930 may receive the RGBN pattern image Ibgnr from the noise reducer 910 and perform brightness estimation based on the RGBN pattern image Ibgnr.

For example, the brightness estimator 930 in the processor 170 may estimate the brightness based on the RGBN pattern image Ibgnr, and output a control signal Ssc for controlling the operation of the IR output device 195 based on the estimated brightness. Accordingly, the IR output device 195 may operate, and according to the operation of the IR output device 195, the color image Ibggr and the IR image Imono robust to illuminance may be acquired.

Specifically, the brightness estimator 930 in the processor 170 may estimate the brightness based on the RGBN pattern image Ibgnr, and when the estimated brightness level is less than or equal to the reference level, output the control signal Ssc for controlling the operation of the IR output device 195.

Unlike this, when the illuminance level sensed by the illuminance sensor is equal to or less than the second reference level, the processor 170 may control the IR output device 195 to output the infrared light.

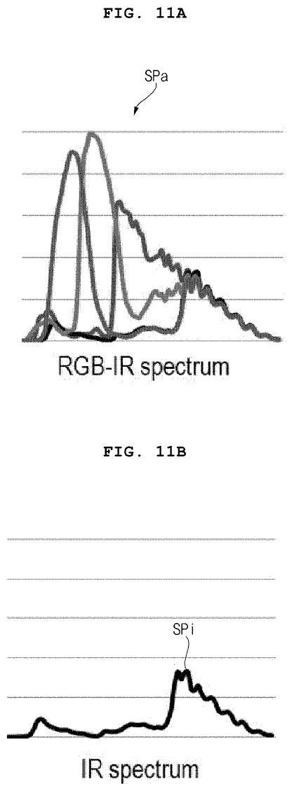

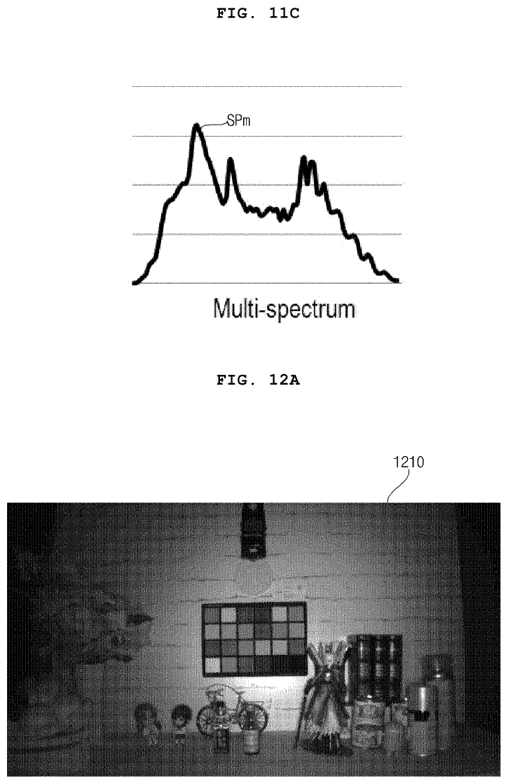

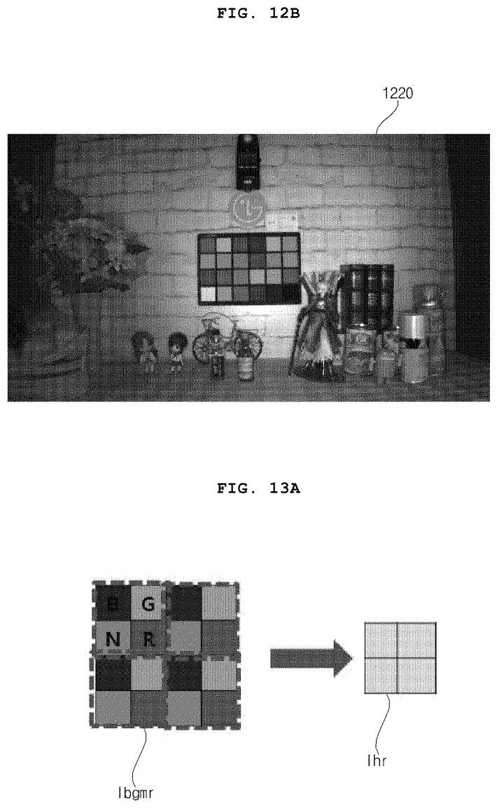

FIG. 10 is an example of an internal block diagram of the image separator of FIG. 9, and FIGS. 11A to 11C illustrate various light spectra.

Referring to the drawings, the image separator 920 may include an IR image generator 1010, an IR estimator 1015, a first color estimator 1020, a color image generator 103, and the like.

Referring to the drawings, the image separator 920 may receive, from the image sensor Ims, a visible light and infrared light spectrum Spa-based GBN pattern image Ibgnr in which the infrared light is not cut-off.

The RGBN pattern image Ibgnr may be respectively input to the IR image generator 1010, the IR estimator 1015, and the first color estimator 1020.

The IR image generator 1010 may generate the multi-spectrum-based IR image Imono based on the RGBN pattern image Ibgnr.

The IR estimator 1015 may estimate an N pattern or IR based on the RGBN pattern image Ibgnr. In particular, the estimated N pattern or the estimated IR may be used for IR cancellation at the time of generating the color image.

The first color estimator 1020 may estimate the first color based on the RGBN pattern image Ibgnr. For example, green (G) may be estimated.

Next, the color image generator 1030 may convert the N pattern in the RGBN pattern image Ibgnr into the first color pattern and output the RGB-based color image Ibggr.

In particular, the color image generator 1030 may remove the N pattern or the estimated IR estimated by the IR estimator 1015 based on the RGBN pattern image Ibgnr, and the first color estimator 1020 may add the estimated green (G). Accordingly, the RGB-based color image Ibggr may be output.

FIG. 11A illustrates a visible light spectrum and an infrared light spectrum SPa, FIG. 11B illustrates an infrared light spectrum Spi input to the image sensor Imsb in the conventional IR camera Dcma, and FIG. 11C illustrates a multi-spectrum Spm input to the image sensor Ims of the camera device 100 of the present disclosure.

The visible light and infrared light spectrum SPa of FIG. 11A may be a light spectrum input before the RGBN filter 915 of the camera device 100 of the present disclosure.

On the other hand, according to the present application, an R filter of the RGBN filter 915 may output red light among the visible light and infrared light spectrum SPa of FIG. 11A, and a G filter may output green light among the visible light and infrared light spectrum SPa of FIG. 11A, a B filter may output blue light in the visible light and infrared light spectrum SPa of FIG. 11A, and an N filter may output red light, green light, blue light, and infrared light among the visible light and infrared light spectrum SPa of FIG. 11A.

Accordingly, the N filter may be set to a bandwidth for transmitting red light, green light, blue light, and infrared light.

That is, a bandwidth of the N filter may include a bandwidth of the infrared light while including a bandwidth of the R filter, a bandwidth of the G filter, and a bandwidth of the B filter.

Accordingly, as illustrated in FIG. 11C, the multi-spectrum (Spm) may be input to the image sensor Ims and converted into an electrical signal.

That is, the multi-spectrum (Spm) may be a light spectrum obtained by summing color light, green light, blue light, and infrared light.

As a result, the IR image generator 1010 of FIG. may generate and output the multi-spectrum (Spm)-based IR image Imono. Accordingly, it is possible to acquire the IR image Imono to illuminance.

Meanwhile, the color image generator 1030 of FIG. may output the RGB-based color image Ibggr. In particular, it is possible to output the color image Ibggr based on a visible light spectrum Spc-based RGGB. Accordingly, it is possible to obtain the color image Ibggr robust to illuminance.

FIG. 12A illustrates the infrared light spectrum Spi-based IR image 1210 of FIG. 11B, and FIG. 12B illustrates a multi-spectrum Spm-based IR image 1220 of FIG. 11C.

It can be seen that the illuminance expressiveness of the IR image 1220 of FIG. 12B is richer than that of the IR image 1210 of FIG. 12A. Also, the overall dynamic range of the IR image is increased.

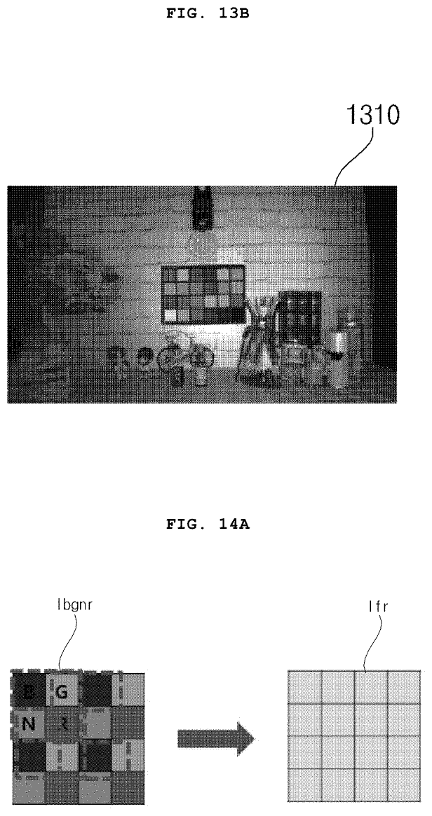

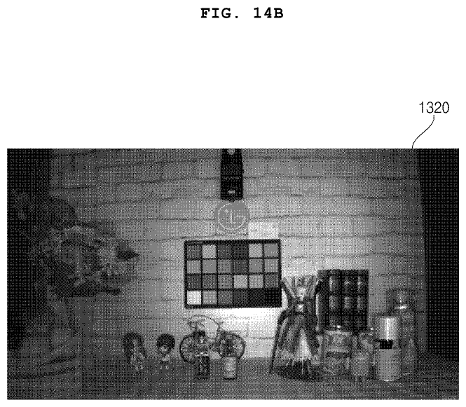

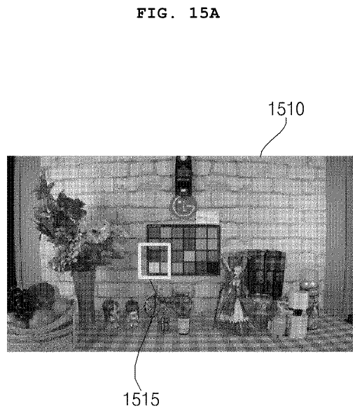

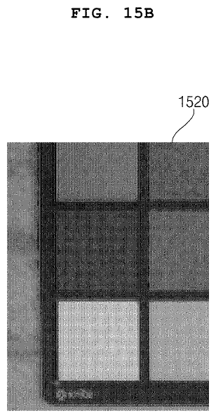

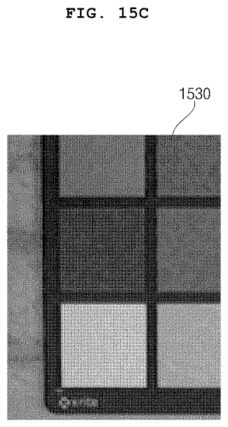

On the other hand, as illustrated in FIG. 13a, when extracting the IR image from the RGBN pattern image Ibgnr in response to the N pattern or the mono component, the processor 170 may output a multi-spectrum-based IR image Ihr having a resolution smaller than a resolution of the RGBN pattern image Ibgnr.

Accordingly, the processor 170 may output the multi-spectrum-based IR image Imono having a resolution smaller than a resolution of the RGBN pattern image Ibgnr through internal signal processing. Accordingly, it is possible to acquire the IR image Imono to illuminance.

On the other hand, as illustrated in FIG. 14A, when extracting the IR image from the RGBN pattern image Ibgnr by overlapping the N pattern or the mono component, the processor 170 may output a multi-spectrum-based IR image Ifr having the same resolution as the RGBN pattern image Ibgnr.

Accordingly, the processor 170 may output the multi-spectrum-based IR image Imono having the same resolution as the RGBN pattern image Ibgnr through internal signal processing. Accordingly, it is possible to acquire the IR image Imono to illuminance.

Meanwhile, since the visible light and infrared light components have different focal positions, artifacts may occur when the color image is generated according to the IR removal on a pixel-wise operation basis.

Accordingly, the color image generator 1030 in the processor 170 may perform signal processing on an edge-based block-wise basis, not on a pixel-wise basis, when the signal processing such as IR removal is performed.

FIG. 15A illustrates a color image 1501 including an edge area 1515.

As described above, when processing a color image on the pixel-wise basis, as illustrated in FIG. 15B, artifacts may occur in the edge area image 1520.

On the other hand, when the signal processing is performed on the edge-based block-wise basis, as illustrated in FIG. 15C, the artifacts in the edge area image 1530 can be significantly reduced.

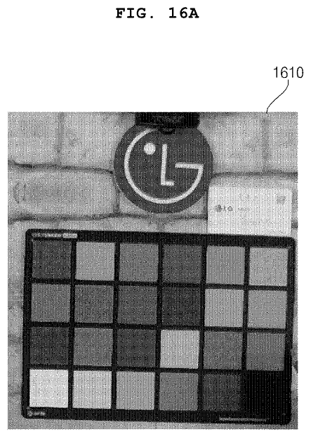

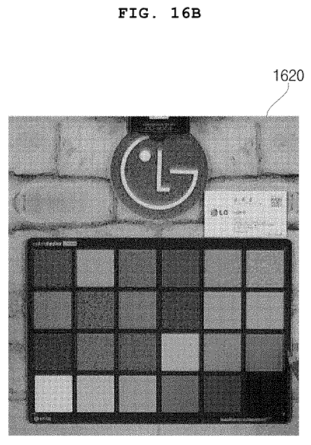

Similarly, FIG. 16A illustrates a color image 1610 obtained by performing the signal processing on the pixel-wise basis, and FIG. 16B illustrates a color image 1620 according to performing the signal processing in the edge-based block-wise basis.

It can be seen that the color image 1620 of FIG. 16B has significantly reduced artifacts and is more robust to noise than the color image 1610 of FIG. 16A.

Meanwhile, the processor 170 may use a nonlinear IR removal technique in consideration of a highlight area when generating a color image.

In particular, the color image generator 1030 in the processor 170 may generate the color image in consideration of the highlight area during the signal processing such as the IR removal.

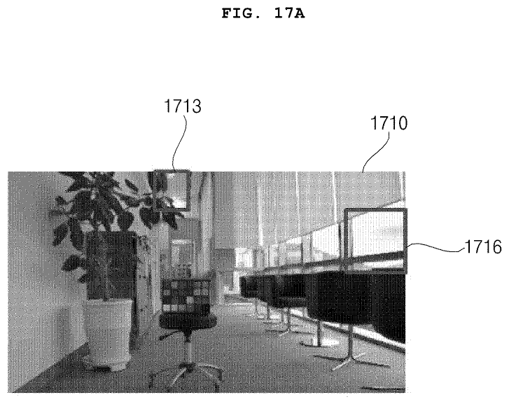

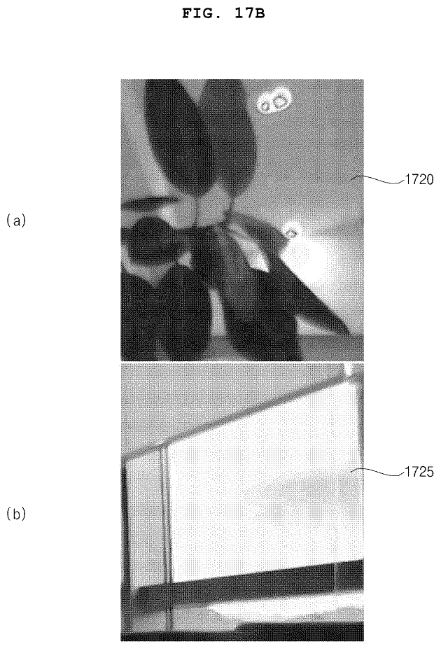

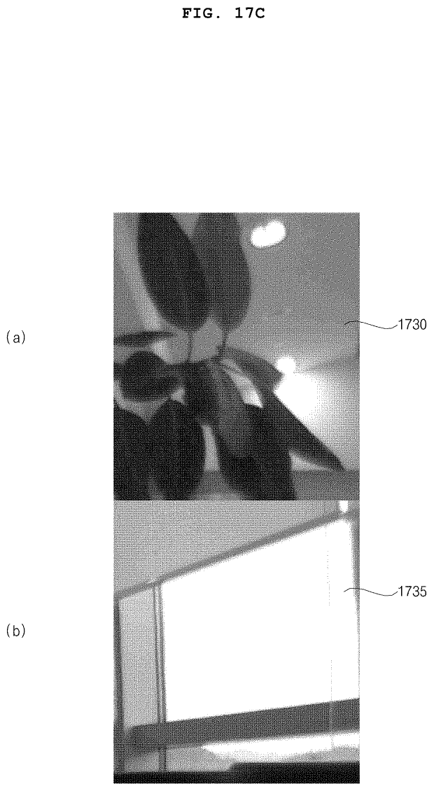

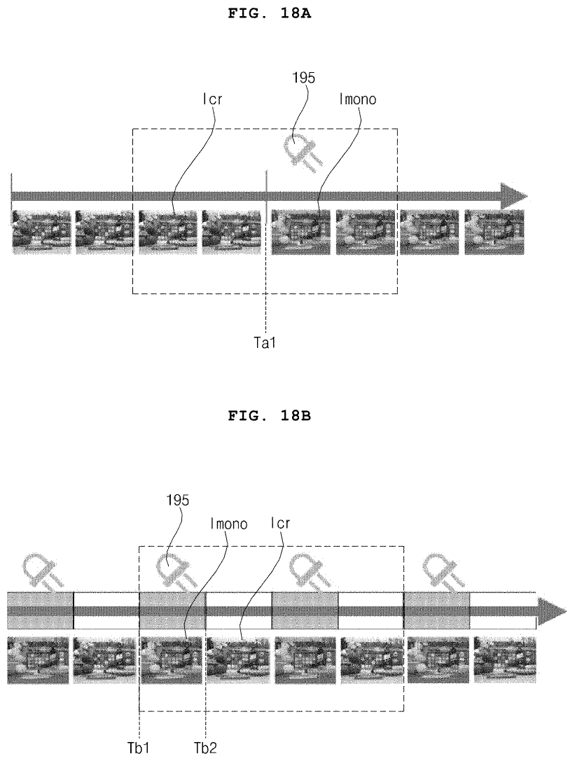

FIG. 17A illustrates a color image 1701 including a first area 1713 and a second area 1716 corresponding to the highlight area.

As described above, when the color image is processed on the pixel-wise basis, as illustrated in FIG. 17B, artifacts may occur in the first area image 1720 and the second area image 1725, respectively.

Accordingly, the processor 170 may use a nonlinear IR removal technique while performing the signal processing on the edge-based block-wise basis during the signal processing such as the IR removal.

That is, the processor 170 may use the nonlinear IR removal technique for the highlight area during the signal processing such as the IR removal.

Accordingly, as illustrated in FIG. 17C, artifacts in each of the first area image 1730 and the second area image 1735 may be significantly reduced. Accordingly, it is possible to acquire the color image robust to noise.

Meanwhile, the processor 170 may estimate the luminance based on the RGBN pattern image Ibgnr, and output the control signal Ssc for controlling the operation of the IR output device 195 based on the estimated luminance.

Specifically, the processor 170 may estimate the brightness based on the RGBN pattern image Ibgnr, and when the estimated brightness level is equal to or less than the reference level, control the IR output device 195 to output the infrared light.

Alternatively, when the illuminance level sensed by the illuminance sensor is equal to or less than the second reference level, the processor 170 may control the IR output device 195 to output the infrared light.

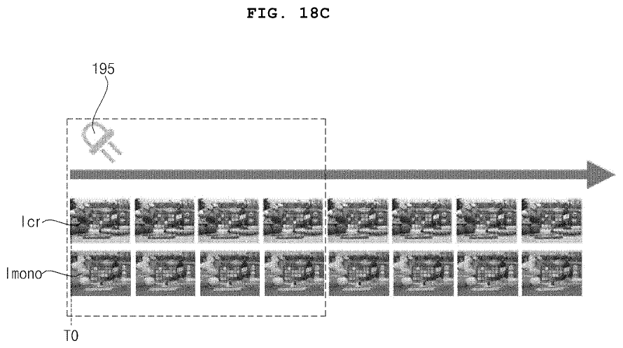

Meanwhile, the operation of the IR output device 195 may be performed in various ways as illustrated in FIGS. 18A to 18C.

For example, as illustrated in FIG. 18A, the IR output device 195 configured to output the infrared light may be turned off and then turned on continuously from time point ta1.

That is, the processor 170 may control the IR output device 195 to be turned off and continue to be turned on from time point ta1.

As another example, as illustrated in FIG. 18B, the IR output device 195 configured to output the infrared light may be turned on alternately such as being turned off, and then turned on at time point tb1 and turned off at time tb2.

That is, the processor 170 may control the IR output device 195 to be turned on alternately, such as being turned on at time tb1 and off at time tb2.

As another example, as illustrated in FIG. 18C, the IR output device 195 configured to output the infrared light may be turned off, and may be continuously turned on from time point to.

That is, the processor 170 may control the IR output device 195 to be continuously turned on from the time point to.

In this way, according to the operation of the IR output device 195, it is possible to acquire the IR image robust to illuminance.

Meanwhile, unlike FIGS. 1A and 1B, for the camera device 100 of the present disclosure, one lens device and one image sensor may be used, and one processor may be used for image signal processing.

Accordingly, it is possible to generate the IR image and the color image robust to illuminance, and it is possible to generate the IR image and the color image of the dynamic range.

In addition, it is possible to reduce artifacts and generate the color image and the IR image robust to noise.

On the other hand, unlike FIGS. 1A and 1B, for the camera device 100 of the present disclosure, it is possible to reduce the manufacturing cost and reduce the space of the device by using one lens device and one image sensor, and as a result, the design of freedom when mounted on various electronic apparatus can be improved.

In addition, although the preferred embodiments of the present disclosure have been illustrated, the present disclosure is not limited to the specific embodiments described above, and can be variously modified by those skilled in the art to which the present disclosure pertains without departing from the gist of the present disclosure claimed in the claims, and these modifications should not be understood individually from the technical ideas or prospects of the present disclosure.

1. A camera device, comprising:
a lens device;
an image sensor configured to convert light passing through the lens device and generate a RGBN pattern image; and
a processor configured to output a multi-spectrum-based IR image and an RGB-based color image based on the RGBN pattern image from the image sensor.

2. The camera device of claim 1, wherein the image sensor includes:
an RGBN filter configured to filter the light passing through the lens device into an RGBN pattern; and
a sensor array configured to convert the light from the RGBN filter into an electrical signal.

3. The camera device of claim 1, wherein the RGBN filter is configured to filter infrared light and visible light into an RGBN pattern.

4. The camera device of claim 1, wherein the processor includes:
an IR image generator configured to generate a multi-spectrum-based IR image based on the RGBN pattern image from the image sensor; and
a color image generator configured to generate an RGB-based color image based on the RGBN pattern image from the image sensor.

5. The camera device of claim 4, wherein the processor further includes a first color estimator configured to estimate a first color based on the RGBN pattern image from the image sensor, and
wherein the color image generator is configured to convert an N pattern in the RGBN pattern image into a first color pattern and output the RGB-based color image.

6. The camera device of claim 1, wherein the processor is configured to output the multi-spectrum-based IR image having a resolution smaller than a resolution of the RGBN pattern image.

7. The camera device of claim 1, wherein the processor is configured to output the multi-spectrum-based IR image having the same resolution as the RGBN pattern image.

8. The camera device of claim 4, further comprising:
an IR output device configured to output infrared light,
wherein the processor is configured to estimate brightness based on the RGBN pattern image, and output a control signal for controlling an operation of the IR output device based on the estimated brightness.

9. The camera device of claim 4, wherein the processor is configured to estimate brightness based on the RGBN pattern image, and when the estimated brightness level is equal to or less than a reference level, control the IR output device to output infrared light.

10. The camera device of claim 1, further comprising:
an illuminance sensor,
wherein when an illuminance level sensed by the illuminance sensor is equal to or less than a second reference level, the processor is configured to control the IR output device to output infrared light.

11. The camera device of claim 1, wherein levels for each wavelength of the multi-spectrum are larger than that of an IR spectrum.

12. The camera device of claim 1, further comprising:
an IR output device configured to output infrared light,
wherein the processor is configured to output the multi-spectrum-based IR image and the RGB-based color image during an operation of the IR output device.

13. The camera device of claim 1, further comprising:
an IR output device configured to output infrared light,
wherein when an operation of the IR output device is stopped, the processor is configured to output only the RGB-based color image without outputting the multi-spectrum-based IR image.

14. An electronic apparatus comprising a camera device,
wherein the camera device, comprising:
a lens device;
an image sensor configured to convert light passing through the lens device and generate a RGBN pattern image; and
a processor configured to output a multi-spectrum-based IR image and an RGB-based color image based on the RGBN pattern image from the image sensor.

15. The electronic apparatus of claim 14, wherein the image sensor includes:
an RGBN filter configured to filter the light passing through the lens device into an RGBN pattern; and
a sensor array configured to convert the light from the RGBN filter into an electrical signal.

16. The electronic apparatus of claim 14, wherein the processor includes:
an IR image generator configured to generate a multi-spectrum-based IR image based on the RGBN pattern image from the image sensor; and
a color image generator configured to generate an RGB-based color image based on the RGBN pattern image from the image sensor.

17. The electronic apparatus of claim 16, wherein the processor further includes a first color estimator configured to estimate a first color based on the RGBN pattern image from the image sensor, and
wherein the color image generator is configured to convert an N pattern in the RGBN pattern image into a first color pattern and output the RGB-based color image.

18. The electronic apparatus of claim 14, wherein the processor is configured to output the multi-spectrum-based IR image having a resolution smaller than a resolution of the RGBN pattern image.

19. The electronic apparatus of claim 16, further comprising:
an IR output device configured to output infrared light,
wherein the processor is configured to estimate brightness based on the RGBN pattern image, and output a control signal for controlling an operation of the IR output device based on the estimated brightness.

20. The electronic apparatus of claim 14, further comprising:
an illuminance sensor,
wherein when an illuminance level sensed by the illuminance sensor is equal to or less than a second reference level, the processor is configured to control the IR output device to output infrared light.
